(19) United States
(12) Patent Application Publication
(10) Pub. No.: US 2026/0242025 A1
(43) Pub. Date: Aug. 20, 2026

(54) MOTORCYCLE MONOCOQUE

(71) Applicant: PIAGGIO & C. S.P.A., Pontedera (IT)

(72) Inventor: Walter ROSELLINI, Pontedera (IT)

(21) Appl. No.: 19/162,354

(22) PCT Filed: Mar. 29, 2024
(86) PCT No.: PCT/IB2024/053095

§ 371 Date: Sep. 4, 2025

(30) Foreign Application Priority Data
Mar. 30, 2023 (IT) 102023000006165

(51) Int. Cl. B62K 11/02; B62J 9/14; B62J 17/02; B62J 25/04

(52) U.S. Cl. CPC B62K 11/02; B62J 9/14; B62J 17/02; B62J 25/04

(57) ABSTRACT

The object of the invention is a monocoque for a motorcycle, a scooter in particular, comprising a frame portion made of a first metal material, and a bodywork portion fastened to the frame portion, made of a second metal material different from and not weldable to the first metal material.

### FIELD OF THE INVENTION

The present invention relates to the technical field of motorcycles. In further detail, the present invention relates to the technical field of frames for motorcycles, in particular scooters.

### BACKGROUND ART

Motorcycles generally have a supporting frame made of metal or metal alloys to which are fastened the main elements, such as engine, transmission, suspensions and the driving cylinder.

The frame in scooters comprises a structural part, typically with an overturned hook shape, with which a plastic bodywork is associated. In certain scooters, such as the Vespa®, the bodywork is made of sheet and is welded to the frame to form a monocoque.

The rigidity and robustness of the materials employed has a considerable effect on the features of maneuverability, robustness and stability of the motorcycle.

On the other hand, it would be desirable to decrease the weight of the motorcycle to ensure the increased facility of use thereof, for example, when pushed or positioned on the central stand during parking, and at the same time reduce the energy consumption when the vehicle is thrust by an electric or thermal engine.

It is the object of the present invention to provide a monocoque for a motorcycle, in particular a scooter, which is lighter than known monocoques, but with comparable features of rigidity and robustness, so as to make the motorcycle more maneuverable and environmentally friendly.

### BRIEF DESCRIPTION OF THE INVENTION

The object of the invention is achieved by a monocoque for a motorcycle, a scooter in particular, comprising a frame portion made of a first metal material, and a bodywork portion fastened to the frame portion, made of a second metal material different from and not weldable to the first metal material.

In particular, the frame portion is made of steel or a steel alloy, while the bodywork portion is made of aluminum or an aluminum alloy, or in any case a lighter material than the material of the frame portion.

Thereby, the frame portion still has the features of rigidity and robustness required for the good maneuverability of the vehicle, while the bodywork parts associated therewith may be made of lighter material so that the motorcycle has an overall smaller weight.

Since the frame portion and bodywork portion may not be welded, the invention provides employing alternative fastening techniques, such as riveting or stapling between the two components.

The invention also relates to a motorcycle, a scooter in particular, that uses the aforesaid monocoque, as well as a method for fastening a bodywork portion to a frame portion to form a monocoque of a motorcycle, a scooter in particular.

Further features and improvements are the subject of the dependent claims.

### BRIEF DESCRIPTION OF THE FIGURES

Further features and advantages of the invention will be apparent from reading the following detailed description, given by way of a non-limiting example, with the aid of the figures shown in the accompanying drawings, in which:

FIG. 1 shows an axonometric view of a body according to an embodiment of the invention.

FIG. 2 shows the body of the preceding figure from a different angle.

FIG. 3 shows a motorcycle assembled on the body of the preceding figures, with an exploded view of the elements which may be employed for covering the fastening elements of the frame portion to the bodywork portion.

FIG. 4 shows some examples of self-piercing rivets which may be employed to fasten the frame portion to the bodywork portion of a body according to the invention.

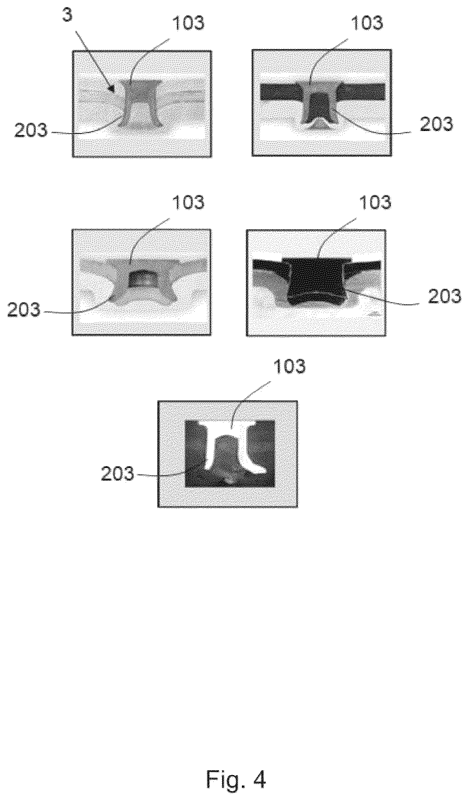

FIG. 5 shows the flow diagram of a method for manufacturing a body according to an embodiment of the invention.

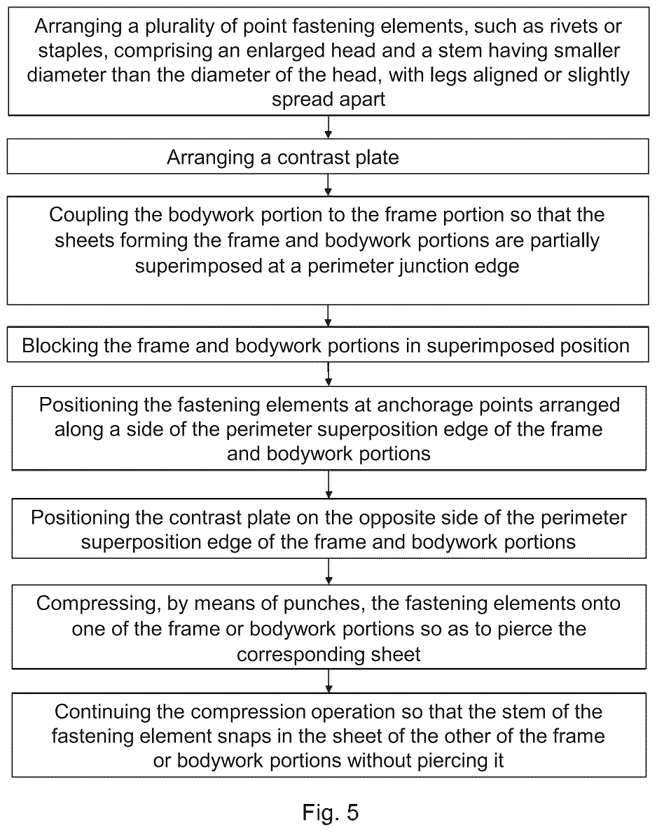

The following description of exemplary embodiments relates to the accompanying drawings. The same reference numerals in various drawings identify the same elements or similar elements. The following detailed description does not limit the invention. The scope of the invention is defined by the accompanying claims.

### DETAILED DESCRIPTION OF THE INVENTION

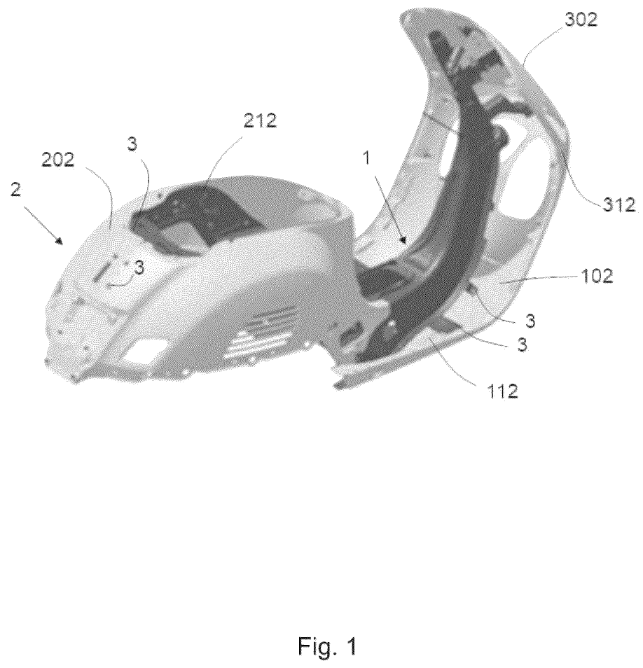

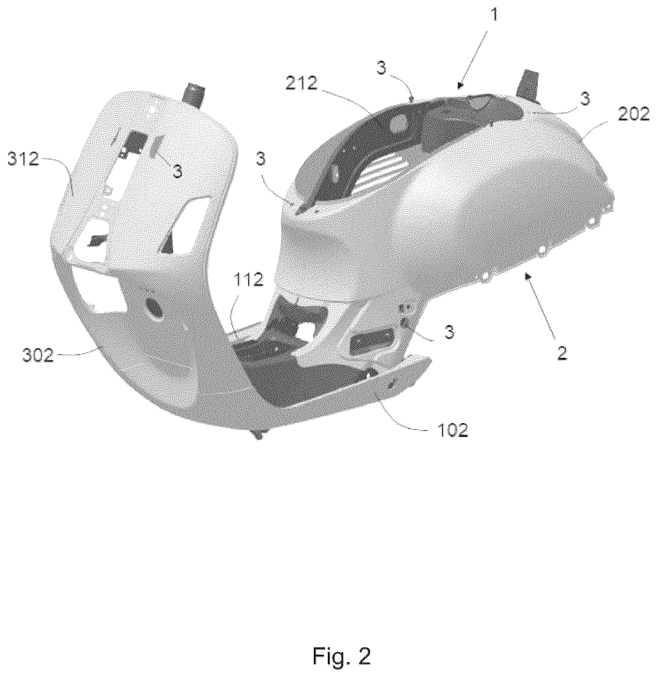

With reference to FIGS. 1 and 2, the monocoque according to a first embodiment of the invention comprises a frame portion 1 extending longitudinally with an overturned hook shape and a bodywork portion 2.

The bodywork portion 2 comprises a plurality of elements connected to the frame portion 1 to obtain a central portion 102 of the motorcycle adapted to obtain a lowered plane constituting a foot board 112 for the driver to rest the feet on, a rear portion 202 of the motorcycle extending from the central portion 102 towards the back, shaped so as to form a laterally closed compartment 212 that is open at the top and bottom, and a front portion 302 of the motorcycle extending from the central portion 102 towards the front, shaped so as to form a front wall 312, called a fairing, for the front protection of the driver's legs.

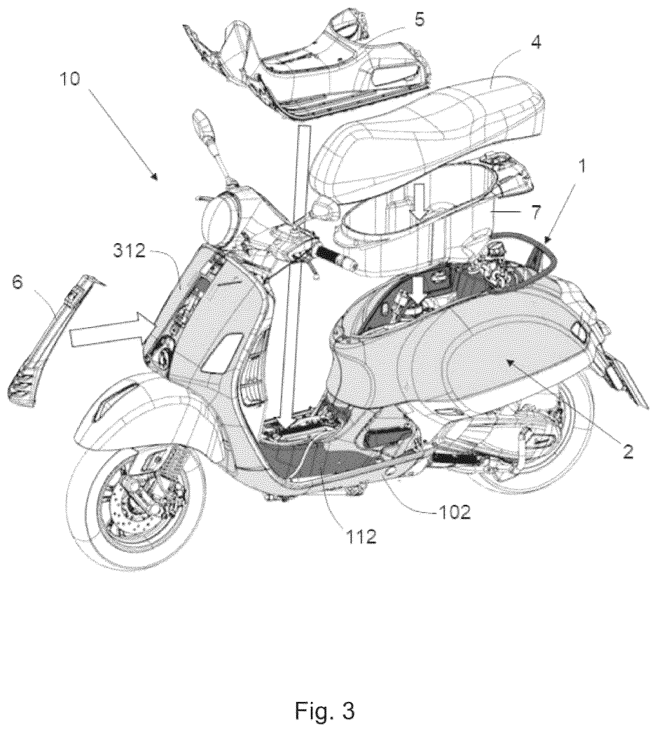

As shown in FIG. 3, compartment 212, conventionally adapted to contain a helmet and cover the engine and the swingarm of motorcycle 10, is provided to be covered at the top by a saddle 4 hinged to an end of the monocoque.

The body is completed by some covering elements, such as a foot board covering 5 for the driver to securely rest the feet on, a plastic material cover 6, also called tie bracket shell, arranged on the front part of fairing 312, and a covering 7 defining a helmet housing inside compartment 212.

The frame portion 1 is made of steel or a steel alloy, while the bodywork portion 2 is made of aluminum or an aluminum alloy. Since the two materials are not weldable, the invention provides that the bodywork portion 2 be fastened to the frame portion 1 in a predefined number of anchorage points by means of point fastening elements 3, such as staples and rivets, which advantageously act on partially superimposed perimeter junction edges of the two bodywork and frame portions.

The frame portion 1 and the bodywork portion 2 may be glued at junction areas so as to increase the fastening robustness.

Certain points 3 for anchoring the frame portion 1 to the bodywork portion 2 are located at the rear compartment 212 so as to be concealed by saddle 4 when the saddle is in closing position of the compartment, and/or by the helmet compartment covering 7.

Other anchorage points 3 are located at the foot board 112 so as to be concealed by the foot board covering 5.

Further anchorage points 3 of the frame portion 1 and the bodywork portion 2 may be located at fairing 312 so as to be concealed from the front tie bracket shell 6.

The rivets may be of the conventional type, i.e., adapted to be inserted in through-holes on the junction area of the sheets and pounded on the inner side.

According to an embodiment, the rivets are of the self-piercing type provided with an enlarged head 103 and a stem 203 of smaller diameter with respect to the diameter of the head. Stem 203 is adapted to pierce the bodywork portion 2 and snap in the frame portion 1, or vice versa.

The employment of self-piercing rivets, such as, for example, those shown in FIG. 3 which are in the Stanley catalogue, is particularly advantageous because it does not require any preliminary piercing operation of the sheets.

The invention also relates to a method for fastening a bodywork portion 2 to a frame portion 1 to form a monocoque of a motorcycle, a scooter in particular, comprising:
arranging a plurality of point fastening elements 3, such as rivets or staples, comprising an enlarged head 103 and a stem 203 having smaller diameter than the diameter of head 103, with legs aligned or slightly spread apart;
arranging a contrast plate;
coupling the bodywork portion 2 to the frame portion 1 so that the sheets forming the frame 1 and bodywork 2 portions are partially superimposed at a perimeter junction edge;
blocking the frame 1 and bodywork 2 portions in superimposed position;
positioning the fastening elements 3 at anchorage points arranged along a side of the perimeter superposition edge of the frame 1 and bodywork 2 portions;
positioning the contrast plate on the opposite side of the perimeter superposition edge of the frame 1 and bodywork 2 portions;
compressing, by means of punches, the fastening elements 3 onto one of the frame 1 or bodywork 2 portions so as to pierce the corresponding sheet;
continuing the compression operation so that stem 203 of the fastening element 3 snaps in the sheet of the other of the frame or bodywork portions without piercing it.

The contrast plate may advantageously be wedge-or double-wedge shaped such as to induce the legs of the stem to spread apart as they are snapped in the sheet.

If the frame portion 1 is made of steel or a steel alloy, while the bodywork portion 2 is made of aluminum or an aluminum alloy, the method advantageously provides piercing the perimeter edge of the bodywork portion 2 with stem 203 of the fastening elements 3 and snapping said stem 203 in the corresponding perimeter edge of the frame portion 2. Thereby, the fastening elements 3, specifically self-piercing rivets, pierce the softer aluminum sheet while they snap in the harder steel sheet to ensure maximum facility and simultaneously, fastening robustness.

1. A monocoque for a motorcycle a scooter in particular, comprising a frame portion made of a first metal material, and a bodywork portion fastened to the frame portion made of a second metal material different from the first metal material, said first and second materials not being weldable to each other, characterized in that the frame portion extends longitudinally with an overturned hook shape, while the bodywork portion comprises a plurality of elements connected to the frame portion to obtain a central portion of the motorcycle adapted to obtain a lowered plane constituting a foot board for the driver to rest the feet on, a rear portion of the motorcycle extending from the central portion towards the back, shaped so as to form a laterally closed compartment open at the top and bottom, and a front portion of the motorcycle extending from the central portion towards the front, shaped so as to form a front wall called a fairing, for the front protection of the driver's legs.

2. A monocoque according to claim 1, wherein the bodywork portion is fastened to the frame portion in a predefined number of anchorage points by means of point fastening elements.

3. A monocoque according to claim 2, wherein the fastening elements act on partially superimposed perimeter junction edges of the two bodywork and frame portions.

4. A monocoque according to claim 2, wherein the fastening elements comprise staples and/or rivets.

5. A monocoque according to claim 4, wherein the rivets are of the self-piercing type provided with an enlarged head and a stem of smaller diameter with respect to the diameter of the head, the stem being adapted to pierce the bodywork portion and snap in the frame portion or vice versa.

6. A monocoque according to claim 2, wherein the monocoque comprises covering elements connectable to the frame portion and/or the bodywork portion so as to conceal the fastening elements

7. A monocoque according to claim 1, wherein the frame portion is made of steel or a steel alloy, while the bodywork portion is made of aluminum or an aluminum alloy.

8. A monocoque according to claim 1, wherein the frame portion and the bodywork portion are glued at junction areas.

9. A monocoque according to claim 1, wherein the compartment conventionally adapted to contain a helmet and cover the engine and the swingarm of the motorcycle, is provided to be covered at the top by a saddle hinged to an end of the monocoque, certain points for anchoring the frame portion to the bodywork portion being located at said compartment so as to be concealed by the saddle when the saddle is in closing position of the compartment and/or by a covering defining a helmet housing inside the compartment

10. A monocoque according to claim 1, wherein the foot board has a foot board covering for the driver to securely rest the feet on, some of the anchorage points of the frame portion and the bodywork portion being located at the foot board so as to be concealed by the foot board covering.

11. A monocoque according to claim 1, wherein some of the anchorage points of the frame portion and the bodywork portion are located at the fairing so as to be concealed by a plastic material cover, also called a tie bracket shell, arranged, or provided to be arranged, on the front part of the fairing.

12. A motorcycle comprising a monocoque according to claim 1.

13. A method for fastening a bodywork portion to a frame portion to form a monocoque of a motorcycle a scooter in particular; comprising:
arranging a plurality of point fastening elements such as rivets or staples, comprising an enlarged head and a stem having smaller diameter than the diameter of the head with legs aligned or slightly spread apart;
arranging a contrast plate;
coupling the bodywork portion to the frame portion so that the sheets forming the frame and bodywork portions are partially superimposed at a perimeter junction edge;
blocking the frame and bodywork portions in superimposed position;
positioning the fastening elements at anchorage points arranged along a side of the perimeter superposition edge of the frame and bodywork portions;
positioning the contrast plate on the opposite side of the perimeter superposition edge of the frame and bodywork portions;
compressing, by means of punches, the fastening elements onto one of the frame or bodywork portions so as to pierce the corresponding sheet;
continuing the compression operation so that the stem of the fastening element snaps in the sheet of the other of the frame or bodywork portions without piercing it.

14. A method according to claim 13, wherein the contrast plate is wedge- or double-wedge shaped such as to induce the legs of the stem to spread apart as they are snapped in the sheet.

15. A method according to claim 13, wherein the frame portion is made of steel or a steel alloy, while the bodywork portion is made of aluminum or an aluminum alloy, the method providing piercing the perimeter edge of the bodywork portion with the stem of the fastening elements and snapping said stem in the corresponding perimeter edge of the frame portion.
